(19) United States
(12) Patent Application Publication
(10) Pub. No.: US 2013/0227386 A1
(43) Pub. Date: Aug. 29, 2013

(54) METHOD OF GATHERING DATA OF AN EVENT-LIKE NATURE FROM ELECTRONIC FORMS

(71) Applicant: Benoit Ferlin, Hallenneslez-Haubourdin (FR)

(72) Inventor: Benoit Ferlin, Hallenneslez-Haubourdin (FR)

(73) Assignee: BANQUE ACCORD, Croix (FR)

(21) Appl. No.: 13/820,366

(22) PCT Filed: Aug. 30, 2011
(86) PCT No.: PCT/FR11/51983

§ 371 Date: May 17, 2013

(30) Foreign Application Priority Data
Sep. 2, 2010 (FR) 10 03511

(51) Int. Cl. G06F 17/24

(52) U.S. Cl. CPC G06F 17/243
USPC 715/221

(57) ABSTRACT

Method of managing an electronic form accessible on an application server (2) via a user terminal (10) provided with at least one input peripheral, said method characterized in that it comprises the following steps:
upon the loading of the electronic form by the user terminal (10), identification (11) of the fields of the electronic form that could be involved in user interactions;
detection and storing in memory of data concerning any event occurring each of the identified fields;
downloading of the data stored in memory during submission of the electronic form;
analysis of the downloaded data.

The present invention relates to the technical domain of online services, and more particularly to the study of user interactions with online electronic forms.

With the generalized use of the Internet and/or intranet, the number of online services, such as e-commerce, e-banking, e-learning and e-government services, is constantly growing. In fact, more and more companies—particularly in the banking segment—tend to offer their services electronically through online applications. Thus, banking and financial transactions can now be performed online, remotely.

In order to respond to the economic and commercial prospects, these online services use various computer resources ranging from the simplest, such as a “contact us” e-mail or an electronic form, to the most complex, such as interfaceable communications tools on the Web 2.0 (instant messaging or chat, social labeling, blog, “Wiki” type dynamic website).

In this context, the electronic form is considered to be one of the principal promoters of online services. In effect, the form makes possible:
quick reactivity: data entry can be speeded up—for example, compared to an e-mail application—through drop-down menus or check boxes;
the acquisition of pre-formatted data, which can be automatically integrated into a database;
the assistance of the Internet user when entering required information: mandatory data (identifier, password for example), or optional data (address, profession, age, e-mail address for example), procedure to follow (for example identification, payment, verification, confirmation);
savings in retranscribing user information (particularly unlike chat or e-mail, in which user information must be extracted and retranscribed, with the risk of error in the retranscription);
the acquisition of pertinent information, for example by leading the user to make a choice from among a list predefined for the purposes of the administrator of the online service.

This is why the electronic form has become an excellent computer resource for online services, whether they be for information, consultation or transactions.

However, online services administrators struggle to design efficient, user-friendly forms because they do not receive critical feedback from users: it would be necessary to have them fill out a satisfaction survey form, which would create a vicious circle.

Thus, the quality of the ergonomics of the electronic forms, which is fundamental for acceptance by Internet users of online services subscription, is generally only incompletely evaluated due to the absence of statistical study on the way Internet users fill out the forms.

Obviously the behavior of Internet users when filling out a form varies depending on the age, sex, socio-professional category, type of terminal and the browser used. However, for commercial as well as ethical reasons it is not feasible to govern access to an online service requiring a form to be filled out by the prior identification of a category to which the Internet user belongs: in principle, any Internet user should be able to fill out a form for access to the service.

Nevertheless, reactions of Internet users to forms are varied and complex. Thus, if the organization of the fields to be filled out is basic, it will be noted that the logic varies according to the individuals. Moreover, that logic can be contrary to the interests of the service provider. Thus, if for some service providers the age of the user is a fundamental item of information on which the supply of the service depends (for example services reserved for adults and prohibited to children), placing the “age” field at the head of the form can deter the user straightaway, who will be diverted from the service.

Similarly, the data entry methodology is fundamental, and to date there is statistically little data about the way Internet users enter information that is requested of them.

One objective of the present invention is to improve the ergonomics of electronic forms in order to facilitate access by Internet users to online services that depend on the submission of these forms.

To that end, a first aspect of the invention relates to a method of managing an electronic form accessible on an application server via a user terminal provided with at least one input peripheral, said method comprising the following steps:
upon the loading of the electronic form by the user terminal, identification of the fields of the electronic form that could be involved in user interactions;
detection and storing in memory of data concerning any event occurring each of the identified fields;
downloading of the data stored in memory during submission of the electronic form;
analysis of the downloaded data, said analysis step comprising a step of identifying chains of successive events resulting from user interactions.

A second aspect of the invention relates to an events recorder for the management of an electronic form accessible on an application server via a user terminal provided with at least one input peripheral, said event recorder being configured to:
when the electronic form is downloaded by the user terminal, identify the fields of the electronic form that could be involved in user interactions;
detect and store in memory data concerning any event occurring in each of the identified fields;
downloading, during the submission of the electronic form, the data stored in memory to an analysis server configured to identify, from among said data stored in memory, at least one chain of successive events resulting from a user interaction.

According to a third aspect, the invention relates to a computer program implemented on a memory device, capable of being run on an electronic data processing unit and comprising instructions for the implementation of the method summarized above.

Other characteristics and advantages of the invention will appear more clearly and in more detail from the following description of preferred embodiments, provided with reference to the appended drawings in which:

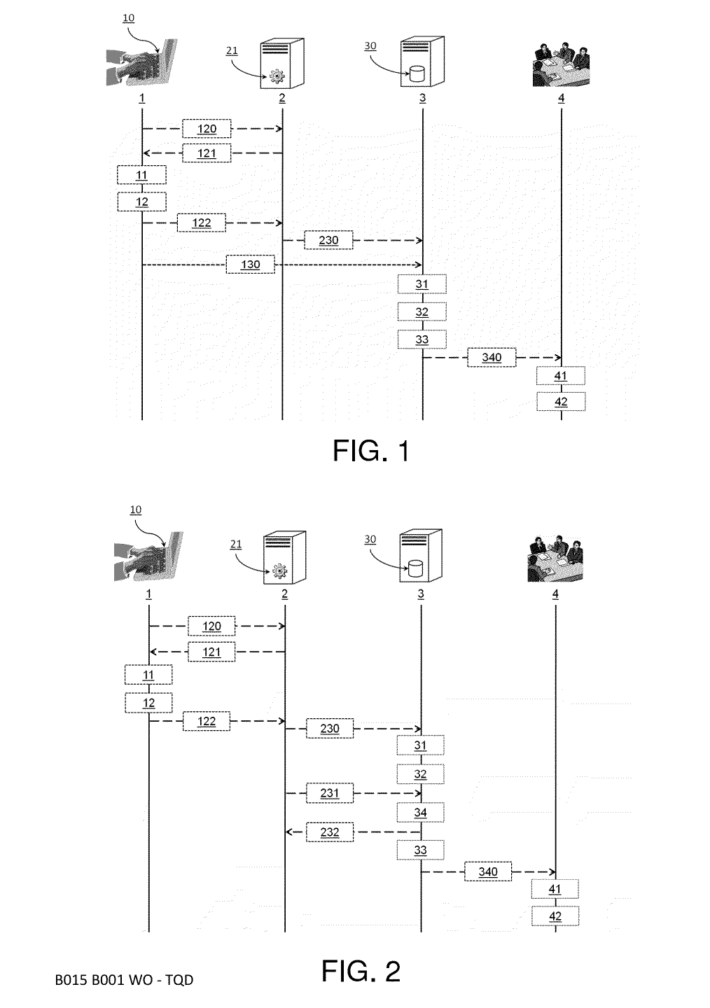

FIG. 1 diagrammatically illustrates a non-limiting functional representation of one embodiment;

FIG. 2 diagrammatically illustrates a variant of embodiment.

Represented in FIG. 1 is user 1 requesting, via user terminal 10, access to online content and/or service from application server 2.

User terminal 10 (a computer, digital tablet, smart phone, portable telephone, or more generally any device allowing user 1 to interact with a remote server) is, in particular, provided with input peripherals and a display means (a screen). Input peripheral is understood here as being any device enabling instructions (for example entering text, pointing) to be sent to user terminal 10. A keyboard, touch screen, keypad, joystick, mouse, trackball, touch pad, graphic tablet or any combination of these items are examples of input peripherals of user terminal 10.

Moreover, user terminal 10 is provided with a Web browser (FireFox®, Fennec®, Opera®, Opera Mobile®, Internet Explorer®, Google Chrome® for example) or any other means allowing a Web site to be consulted online via application server 2. Said Web browser is disposed to transmit a request for access to an online service and/or content, as well as to display the response to said request transmitted from application server 2.

Communication between user terminal 10 and application server 2 is established according to a simultaneously supported browser protocol (http, https, WAP for example).

Application server 2 allows access to (or hosts) at least one Web site (or a WAP site) comprising an electronic form. By way of non-limiting example, application server 2 offers an online service such as an online application for bank loan, requiring an electronic form to be filled out by a user who wishes to benefit from said service.

In his interactions with the contents placed online via application server 2, user 1 transmits a request 120 for access to an electronic form through application server 2. In response, application server 2 returns to user 1 the requested electronic form 121, including an event recorder.

The event recorder is a computer program (i.e., a set of lines of code representing instructions) attached to the electronic form requested by user 1. According to one particular embodiment, the event recorder is integrated into the source code of the electronic form.

It should be noted, however, that the event recorder is independent of the electronic form requested by user 1, and can be integrated into any other electronic form.

The event recorder seeks to allow the reconstruction over time of the way in which the requested electronic form is filled out by user 1. In this regard, there are three phases:
an initialization phase of inventorying all fields of the electronic form that may be involved in user interactions;
an execution phase during which the event recorder detects and stores in memory any event that occurs in each of the inventoried fields of the electronic form;
a downloading phase allowing the data stored in memory to be added to the electronic form when it is submitted by the user.

A “field” of an electronic form is understood here as any element comprising the electronic form, or more generally any graphic interface component included in the electronic form (for example, icon, pushbutton, check box, radio button, command menu, contextual menu, tab, scroll bar, text area, pop-up help, dialog box, floating window, hypertext link). Furthermore, a “user interaction” designates here any instruction (such as selection, data entry, pointing) triggered by user 1 via a data entry peripheral of user terminal 10 or by a computer program (a bot for example).

When user 1 downloads the electronic form 121 including an event recorder, said event recorder in an initialization phase,
performs an exploration of the electronic form (step 11 of FIG. 1) in order to identify all of the fields whose values can be modified by user 1 (a data area, a drop-down menu, a check box, a radio button, a button, a link to another document for example), and
stores in memory (step 12 of FIG. 1) the properties of the identified fields; i.e., for each identified field, it stores in memory the name, type (button, check box, file, hidden, image, password, radio, reset, select-one, select-multiple, submit, text, text area for example), and the initial value (empty, checked for example).

Thus, the event recorder constructs a detailed universal set characterizing all of the fields present in the electronic form downloaded by user 1.

In a particular embodiment, the event recorder browses the electronic form to extract the structure from it (i.e., all of the fields present in the electronic form) to store said structure in memory in a Structure[ ] table in the following form:

| Property | Description | |
|---|---|---|
| i | Form number | |
| j | Number of appearance of the field in the structure | |
| Idx | Index of the field in the “i/j” format | |
| type | Type of field: | |
| | button | A |
| | check box | B |
| | file | C |
| | hidden | D |
| | image | E |
| | password | F |
| | radio | G |
| | reset | H |
| | select-one | I |
| | select-multiple | J |
| | submit | K |
| | text | L |
| | textarea | M |
| | window | X (browser) |
| | unrecognized | Z |

| | |
|---|---|
| val_ini | Initial value of the field |
| name | HTML name of the field |
| id | HTML identifier of the field |

Each field of the electronic form is therefore indexed by a number of the electronic form and its number of appearance in the structure of said electronic form.

During the execution phase, a “listener” is associated with each referenced field, in order to detect any event occurring therein, and as a result to trigger the storing of said event in memory. Non-limiting examples of events are:

| Listener | Description |
|---|---|
| keydown | A key is pressed |
| keypress | A key is “pressed” |
| keyup | A key is released |
| focus | The field captures the focus |
| Blur | The field loses the focus |
| select | An item is selected from a list |
| paste | A “paste” event occurs in the field |
| Cut | A “cut” event occurs in the field |
| copy | A “copy” event occurs in the field |
| change | The contents of the field have changed value |
| click | The field was clicked |
| dblclick | The field was double clicked |
| contextmenu | A contextual menu was triggered in the field |
| mousedown | A mouse button is pressed in the field |
| mouseup | A mouse button is released in the field |
| resize | The user resizes the window of the electronic form |
| mouseover | The mouse arrives above the field |
| mouseout | The mouse leaves the field |

In particular, the “focus” event occurs when a referenced field is selected. When said field loses the “focus,” a “blur” event occurs. In particular, these two events make it possible to know that user 1 is performing a “swap” from the electronic form to another document. The “focus” and “blur” events provide information, among other things, about the attention of user 1 to the electronic form.

The listeners programmed to detect the “focus” and “blur” events are implemented in the “window” object of the DOM (Document Object Model), allowing the triggering of a memorization function associated with the “window” object.

The “resize” event results in the resizing of the window of the electronic form by means of one of the following browser functions: “handle” (generally accessible in the lower right corner of the browser), “full-screen,” “minimize” or “enlarge” (these last three are generally in the upper right corner of the browser).

Time management is accomplished by means of a variable supplied with the current time, making it possible to calculate the time elapsed (in milliseconds) between two consecutive events and/or the duration of an event (also in milliseconds).

In one particular embodiment, every event captured is stored in a Trace[ ] table, comprising the following properties:

| Property | Specification |
|---|---|
| i | Sequence number of the event |
| dh | Number of milliseconds elapsed since the |
| | preceding event |
| ctrl | Index of the object on which the event occurred |
| keycode | Keycode or charcode on a key-type event |
| selTxt | Text selected in a “text” or “textarea” type field |
| selBeg | Offset in the field of the beginning of the selected text |
| selEnd | Offset in the field of the end of the selected text |
| new_val_empty | Indicator showing when the new value of the |
| | field is “empty.” |
| special_key | Makes it possible to know when a special |
| | key has been pressed during the event |
| event | Code of the event occurred |
| new_val | New value of the field |
| mouse | Last known position of the mouse before the event |
| | occurred |

Preferably, the data stored in memory related to an event captured by a listener include: the event, the field in which the event occurs, the elapsed time (in milliseconds) since the preceding event, the instruction transmitted from the input peripheral to the user terminal (i.e., the value of the key pressed on the keyboard, or the mouse button pressed), the content of the selected text/item, a beginning and/or end sign of the selected text, the new value of the field, a change in the value of a field, the status of the special keys like “CTL,” “ALT” and “SHIFT,” for example.

Moreover, when a given event is generated by:
a mouse click, then that click is identified (left click, middle click, right click);
the pressing of the key (keydown—keypress and keyup event), then the “keycode” of the key (for the keydown and keyup events) or the “charcode” (for the keypress event) is identified.

Furthermore, the pressing of one or more special keys is stored in memory, i.e., the “Ctrl,” “Alt” or “Shift” keys for example, when the event occurs in the “special_key” property. For example, the “Ctrl” property is associated with the field in which the event occurs. If the event concerns the electronic form window itself, then the “focus” or “blur” event is stored for this window (i=0, j=0, according to the Structure[ ] table). If the event concerns an unknown type of field (the origin of which can be a bug in the browser), the value “none” is assigned to the “ctrl” property so that the event is unstacked from the Trace[ ] events table.

By way of example, if the event concerns a “text,” “textarea” or “password” type element, and text is selected, the following information is stored in memory:
selTxt: Selected text;
selBeg: Offset in the element of the beginning of the selection;
selEnd: Offset in the element of the end of the selection.

If the event concerns a “select-one” or “select-multiple” type element, the property “new_val” is supplied which will format the selected elements in a string in the following way:

‘[’ character

For each selected item:
Order number of the item,
The text of the item in which the character “|” is replaced by “&pipe” and the character “/” by “&slash,”
The “/” character
   “]” character.

If the event concerns a “radio” or “check box” type field, the “new_val” property is supplied with a “1” or “0” (1: checked or selected, 0 if not).

Finally, for all other fields for which the “value” property is defined (text, textarea, password), the “new_val” property is supplied with the value of the element replacing the “|” character with “&pipe.” In particular, if the new value is empty while the preceding one was other than empty, the “new_val_empty” property is set at 1. Finally, the “ex_val” property of the field is supplied with a new value.

In one embodiment, an alphabetic character associated with the triggered event is stored in the “event” property, while adhering to a certain nomenclature, for example the following:

| Event | Event code |
|---|---|
| keydown | A |
| keyup | B |
| keypress | C |
| focus | D |
| blur | E |
| select | F |
| paste | G |
| cut | H |
| copy | I |
| change | J |
| click | K |
| dblclick | L |
| contextmenu | M |
| mousedown | N |
| mouseup | O |
| resize | P |
| mouseover | Q |
| mouseout | R |
| Other | Z |

It should be noted that the stored data concern the way user 1 interacts with the electronic form, and not the content of his interactions (i.e., the text entered).

The submission of the electronic form (step 122 of FIG. 1) by user 1 to application server 2 triggers the downloading phase allowing the stored data to be added to the electronic form.

In particular, the downloading phase makes it possible to:
format the stored data during the initialization and execution phase in a technical trace;
add, in a dynamically created area, the technical trace to the electronic form to be submitted.

To do this, first, in order to avoid any problem of interpretation of the technical trace with certain “special” characters (such as “<,” “?” for example), such characters are preferably replaced by adhering to a certain nomenclature such as the following:

| Character | Replacement string. |
|---|---|
| < | %3c |
| = | %3d |
| > | %3e |
| [symbol] | %26 |
| ? | %3f |

The technical trace is then formatted to comprise a header, a structure and the trace of events already stored in memory.

The header, bounded by <header> and </header> markers, enhances the information included in the events trace by including, but not limited to, the elements of the following table.

| Name | Specification |
|---|---|
| version | Recorder version (for example 1.0) |
| host | Name of the host on which the event recorder is running (for example |
| | www.oney.fr) |
| pathname | Path of the page on the site (for example,/ouverture/carte.php) |
| search | String of possible parameters of the URL (for example |
| | ?mode = subscription) |
| Date_Start | Date - time the form was loaded |
| Date_End | Date - time at the time the function was executed |
| appCodeName | Code name of the browser (for example, Mozilla) |
| appMinorVersion | Minor version of the browser |
| appName | Full name of the browser (for example Netscape) |
| appVersion | Version of the browser (for example 5.0 (Windows; U; Windows NT 6.1) |
| cookieEnabled | Boolean operator indicating whether or not the browser accepts cookies |
| cpuClass | Processor type |
| language | Language of the browser (for example fr) |
| onLine | Boolean operator indicating whether or not the browser is connected to |
| | the Internet |
| platform | Name of the operating system (for example Win32) |
| systemLanguage | Language code of the operating system |
| userAgent | Concatenation of various items of information about the browser (for |
| | example, Mozilla/5.0 (Windows; U) |
| userLanguage | Language code of the browser |
| availHeight | Number of usable vertical resolution pixels of the screen |
| availWidth | Number of usable horizontal resolution pixels of the screen |
| colorDepth | Depth of colors in number of bits |
| height | Actual vertical resolution of the screen |
| width | Actual horizontal resolution of the screen |
| innerHeight | Height in pixels of the visible content area of the browser |
| innerWidth | Width in pixels of the visible content area of the browser |
| XOffset | Position of the page in the browser (slider box) in the horizontal |
| | direction |
| YOffset | Position of the page in the browser (slider box) in the vertical direction |

Provided below is an example of a header of a technical trace (the character “|” is replaced by “&pipe” in each property containing text):

<header>1.0|www.pcaba.fr|/test-
pool/lab_coordinates.php||1269965021999|1269965154646|Mozilla|;
SP3;|Microsoft Internet Explorer|4.0 (compatible; MSIE 6.0; Windows
NT 5.1; SV1; .NET CLR 2.0.50727; .NET CLR 1.1.4322)|true|x86|
undefined|true|Win32|fr|Mozilla/4.0 (compatible; MSIE 6.0; Windows
NT 5.1; SV1; .NET CLR 2.0.50727; .NET CLR
1.1.4322)|fr|996|1280|32|1024|1280|881|1229|0|0</header>

The structure of a technical trace, bounded by <structure> and </structure> type markers, comprises a description of the referenced fields of the electronic form as indicated in the following:

| Name | Specification | |
|---|---|---|
| Idx | Index of the field, composed of the number of the form | |
| | followed by “/” then by the number of the field in the form | |
| name | HTML name of the field | |
| id | HTML identifier of the field | |
| type | Type of field: | |
| | button | A |
| | check box | B |
| | file | C |
| | hidden | D |
| | image | E |
| | password | F |
| | radio | G |
| | reset | H |
| | select-one | I |
| | select-multiple | J |
| | submit | K |
| | text | L |
| | textarea | M |
| | window | X (browser) |
| | unrecognized | Z |

| | |
|---|---|
| val_ini * | Initial value of the field |
| val_end * | Final value of the field |

Following is an example illustrating the structure of a technical trace (the character “|” is replaced by “&pipe” in each property containing text):

<structure>0/0|window||X|||0/1|eventid||D||next|0/2|salutation|salutation|
I|[0: ]|[1:Mr.]|0/3|firstname|firstname|L||Benoit|0/4|lastname|lastname|L||
Ferlin|0/5|maidenName|maiden-name|L|||0/6|birthdateDay||I|[0:--]|[22:22]|
0/7|birthdateMonth||I|[0:--]|[6:06]|0/8|birthdateYear||I|[0:----]|[30:1963]
|0/9|birthCountry|birth-country|I|[1:France]|[1:France]|0/10|
BirthDepartment|birth-department|I|[0:Select]|[69:Morbihan]|0/11
|birthCity|birth-city|L||GUER|0/12|streetNumber|street-number|L||1 RUE
NATIONALE|0/13|residenceBuilding|residence-building|L|||0/14|floor|floor
|L|||0/15|postalCode|postal-code|L||59000|0/16|placeCalled|placeCalled|
L|||0/17|township|township|L||LILLE|0/18|landlineTelephone|landline-
telephone|L|||0/19|mobileTelephone|mobile-telephone|L|||0/20|email|email-
address|L||bferlin@test.fr|</structure>

| Idx | name | type | val_ini | val_end |
|---|---|---|---|---|
| 0/0 | window | X (window) | | |
| 0/1 | eventid | D (hidden) | | next |
| 0/2 | salutation | I (select-one) | [0:] | [1:Dear Sir] |
| 0/3 | first name | L (text) | | Benoit |
| 0/4 | last name | L (text) | | Ferlin |
| 0/5 | maidenName | L (text) | | |
| 0/6 | birthdateDay | I (select-one) | [0:--] | [22:22] |
| 0/7 | birthdateMonth | I (select-one) | [0:--] | [6:06] |
| 0/8 | birthdateYear | I (select-one) | [0:----] | [30:1963] |
| 0/9 | birthCountry | I (select-one) | [1:France] | [1:France] |
| 0/10 | birthDepartment | I (select-one) | [0:Select] | [69:Morbihan] |
| 0/11 | birthCity | L (text) | | GUER |
| 0/12 | streetNumber | L (text) | | 1 RUE |
| | | | | NATIONALE |
| 0/13 | residenceBuilding | L (text) | | |
| 0/14 | Suite/unit/floor/etc. | L (text) | | |
| 0/15 | postalCode | L (text) | | 59000 |
| 0/16 | placeCalled | L (text) | | |
| 0/17 | township | L (text) | | LILLE |
| 0/18 | landlineTelephone | L (text) | | |
| 0/19 | mobileTelephone | L (text) | | |
| 0/20 | email | L (text) | | bferlin@test.fr |

The events trace comprises all of the events occurring during the execution phase on the form and which can be bounded by the markers “<trace>” and “</trace>”. The trace is composed of the following elements, each separated by the character “|”:

| | |
|---|---|
| Name | Specification |

| | |
|---|---|
| Dh | Number of milliseconds elapsed since the preceding |
| | event |
| Ctrl | This is the identifier of the field, i.e., “the ID of |
| | the structure” |
| event | Event code |

| | |
|---|---|
| keydown | A |
| keyup | B |
| keypress | C |
| focus | D |
| blur | E |
| select | F |
| paste | G |
| cut | H |
| copy | I |
| change | J |
| click | K |
| dblclick | L |
| contextmenu | M |
| mousedown | N |
| mouseup | O |
| Other | Z |

| | |
|---|---|
| keycode * | Keycode or charcode on a key-type event |
| selTxt * | Text selected in a “text” or “textarea” type field |
| selBeg | Offset in the field of the beginning of the selected text |
| selEnd | Offset in the field of the end of the selected text |
| new_val * | New value of the field |
| new_val_empty | Indicator showing when the new value of the field |
| | is “empty.” |
| spe_key | Indicates if a special key has been pressed during |
| | the event |

For reasons of confidentiality, the events trace is preferably encrypted. In particular, the contents of the structure of the technical trace can also be encrypted.

In one non-limiting embodiment of the encryption of the event trace, encryption keys are randomly calculated by the event recorder and stored in the “window.name” system variable. Advantageously, this method of encryption makes it possible to preserve the same method of encryption for all loaded (i.e., open) electronic forms in the same browser.

For this purpose, in a preferred embodiment, three encryption matrices are defined from three different zones of an input peripheral of the user terminal (a keyboard):
matrix A (mA): the keys F1 to F12;
matrix B (mB): the keys 1 to 0 of the main keyboard and the same keys of the digital keypad;
matrix C (mC): the keys A to Z.

The keys numbered according to a keys encryption table make it possible to obtain encryption matrices composed of keys related to each zone.

Each matrix is initialized with its corresponding key numbers, for example:
mA: numbers from 1 to 11;
mB: numbers from 17 to 26; and
mC: numbers from 31 to 40+numbers from 45 to 54+numbers from 59 to 64.

For each matrix established in this way, a large number (for example 1,000) of 2×2 permutations of the elements of each matrix is produced.

These matrices are then saved in the “window.name” variable. The following example illustrates the format of this variable (the figures used here are solely by way of illustration):

[mA = new Array (2,12,8,1,6,3,10,9,7,5,4,11);
mB = new Array (19,20,22,24,17,21,23,25,26,18);
mC = new Array
(48,60,64,31,39,47,45,50,63,54,40,46,49,62,35,36,38,53,61,59,37,32,51,
33,52,34);]

The encryption matrices mA, mB and mC are generated when the event recorder is loaded. If, during a subsequent loading of the event recorder, the presence of matrices is detected in the “window.name” variable, the string is reworked to delete the opening and closing brackets and a simple evaluation of the string allows the matrices to be loaded while keeping the same permutations.

In order to establish a table of mixed keys while respecting these blocks, a table named tcp[ ] indexed from 0 to 105 includes the matrices mA, mB and mC:

```
var tcp = new Array( );
for (i = 0; i < 105; i++) {
        tcp[i] = i;
        if ((i > 0) && (i < 13)) tcp[i] = mA[i−1];
        if ((i > 16) && (i < 27)) tcp[i] = mB[i−17];
        if ((i > 94) && (i < 105)) tcp[i] = mB[i−95];
        if ((i > 30) && (i < 41)) tcp[i] = mC[i−31];
        if ((i > 44) && (i < 55)) tcp[i] = mC[i−35];
        if ((i > 58) && (i < 64)) tcp[i] = mC[i−39];
}
```

It should be noted that when a key is pressed, three events occur:
keydown: the key is held down and the keycode of the key is intercepted;
keypress: the key is pressed, and the charcode of the key is intercepted;
keyup: The key is released, and the keycode of the key is intercepted.

It is particularly advantageous to preserve a coherence between the “keycode—charcode” values and the value of the characters entered, making it possible to detect for example that user 1 has corrected his name by reversing two characters from a preceding entry.

Following is an example illustrating the encryption method in which two keys, for example 53 (L) and 64 (N) according to a keys encryption table, have been reversed during the creation of the encryption matrices:

| No. of the | | | | | |
|---|---|---|---|---|---|
| key | KeyCode | CharCode | Character | CharCode M | Character |
| 53 | 76 | 108 | l | 76 | L |
| 64 | 78 | 110 | n | 78 | N |

The following two tables, respectively of correspondence between an element and its key number and the correspondence between a key number and its element, are used by the encryption method.

The table of correspondence between an element and its key number can be presented in this way:

| Name | Description | Example |
|---|---|---|
| kd | Correspondence between a keyCode and a key | kd[76] = 53 |
| | number | |
| kc | Correspondence between a charcode and a key | kc[108] = 53 |
| | number | |
| kcm | Correspondence between an “uppercase” | kcm[76] = 53 |
| | charcode and a key number | |
| since | Correspondence between a character and its key | since[‘l’] = 53 |
| | number | since[‘L’] = 53 |

The table of correspondence between a key number and its element can be presented in this way:

| Name | Description | Example |
|---|---|---|
| tkd | Correspondence between a key number and a | tkd[64] = 78 |
| | keycode | |
| tkc | Correspondence between a key number and a | tkc[64] = 110 |
| | charcode | |
| tkcm | Correspondence between a key number and an | tkcm[64] = 78 |
| | uppercase charcode | |
| tc | Correspondence between a key number and a | tc[64] = ‘n’ |
| | lowercase character | |
| tcm | Correspondence between a key number and an | tcm[64] = ‘N’ |
| | uppercase character | |

The encryption of a keycode following keydown and keyup events comprises the following steps:
retrieve from the kd table the number of the key associated with the keycode to be encrypted: in this example kd[76]=53;
read the permutation of the key in question in the tcp table: in this example, tcp[53]=64;
search in the tkd table for the keycode associated with the key number obtained: in this example, tkd[64]=78.

The encryption of a charcode following the keypress event comprises the following steps:
retrieve from the kc table the number of the key associated with the charcode to be encrypted (if this element is not defined, then this key number is retrieved from the kcm table): in this example kcm[76]=53
read the permutation of the key in question in the tcp table: in this example, tcp[53]=64;
search in the tkc table for the charcode associated with the key number obtained; in this example, tkd[64]=78.

A comparison of the capitalizing of a character with the character itself makes it possible to determine if a character is uppercase or lowercase (except for special characters such as “à”, “ù” or “ç”). For example, according to the aforementioned examples, since[‘L’]=53, then tcp[53]=64 corresponds in tcm to ‘N’, i.e., tcm[64]=‘N’.

Of course, other methods of encrypting the event trace can be used.

In one embodiment and for security reasons, the formatted technical trace is attached in a hidden manner (a “hidden” type element) to the electronic form to be submitted by user 1 to application server 2.

In another embodiment, even if user 1 cancels the submission or abandons the electronic form (for example, back button in the browser, closing the page of the electronic form), the technical trace is sent to application server 2 (step 122 of FIG. 1) or to analysis server 3 (step 130 of FIG. 1). In this case, the technical trace makes it possible to identify the areas of the form where user 1 stopped. For example, this enables the fields to be identified that represent an obstacle to users to completing their transactions.

In one embodiment, application server 2 is provided with plugin program 21 to extract the technical trace from the submitted form and transfer it to analysis server 3. In particular, the purpose of said transfer is not to disturb the operation of application server 2, which is dedicated to processing the contents of the submitted form.

As a result, the management of the technical trace is reserved for analysis server 3 in order not to slow down the processing time by application server 2 of the contents of the form submitted by user 1.

As a variant, the technical trace is transmitted directly (step 130 of FIG. 1) to analysis server 3.

Analysis server 3 is configured to:
verify the coherence of the technical trace (step 31 of FIG. 1), for example the structure of the trace, the presence of information in the header;
analyze the events trace included in the technical trace (step 32 of FIG. 1); and
store in memory (step 33 of FIG. 1) the analysis of the technical trace in database 30.

The analysis step 32 of an events trace comprises in particular several steps such as:
the standardization of the events trace, for example by deleting superfluous events from it, depending on the browser used by user 1 (for example, changing from one field to another generates in Internet Explorer an event of the type “the window gains the focus”);
the identification of successive chains of events resulting from user interactions, for example the chain of events “mousedown-mouseup-contextmenu-paste” corresponding to the action “paste in an area by means of the context menu”;
The evaluation of the keystroke dynamic (normal stroke: keydown-keypress-keyup; quick stroke: time between successive key up and key down, repetitive stroke: duration of the keypress time).

The succession of chains of events resulting from user interactions can be done, according to a particular embodiment, by analyzing the trace by a technique called “regular expressions”: a letter of the alphabet is associated with each event of the trace and a string of characters composed of all of the events is formed, one after the other. Each regular expression is searched in the chain of events, and when it is found, an “analysis flag” is associated with it making it possible to know that the elementary events correspond to a particular action.

At this level of analysis, the events trace is broken down into comprehensible events, in other words into user interactions: a key was pressed, a field underwent a “paste” action, or a box was checked for example.

Advantageously, the translation into user interactions of all of the events included in the events trace makes it possible to reconstruct over time the way the electronic form was filled out by user 1. More specifically, this step makes reconstruction possible by tracing user interactions (text entry, item selection, page switching for example) particularly by taking into account the time aspect (duration/order of user interactions) or the scenario in which the electronic form is filled out.

The evaluation of the keystroke dynamic can be carried out by calculating, for each event of the trace, the Levenshtein distance or any other measure of similarity between two chains of events) resulting from changes of value of the zone in which the event occurs. The Levenshtein distance quantifies the algorithmic cost of going from one word to another.

This step of evaluating the keystroke dynamic makes it possible to identify the way the fields of the electronic form have been filled out. Indeed, three types of keystrokes are distinguished:
normal keystroke: The field is modified following the “keydown+keypress+keyup” events;
rapid keystroke: this event occurs when user 1 taps quickly on the keyboard; the sequence is characterized by the fact that the “keyup” event of the first key pressed has not even occurred yet when the “keydown” event of the next key occurs. This analysis tends to show that the user who made the entry is accustomed to entering this information on the keyboard;
repetitive keystroke: this event occurs when the user presses on a key for a long time and triggers the repetitive entry of the same character in the field.

Moreover, the analysis of the technical trace also makes it possible to identify the fields that have been modified by means of the “copy/paste,” by the “auto-complete” feature offered by some browsers, or by means of bots for example.

This analysis step makes it possible to reconstruct the way in which the electronic form has been filled out by user 1. For example, user 1:
has clicked on the “name” field, has filled it in by means of the keys of the keyboard by making X normal entries, Y quick entries, Z corrections;
has moved from the “name” field to the “address” field by means of the tab key;
has switched to a window other than the window of the electronic form (the window of the electronic form has lost the “focus,” and a “blur” event has subsequently occurred);
has reactivated the “address” field of the electronic form (“focus” event occurred in the “address” field);
Has pasted content into the “address” field by means of the context menu (the following chain of events occurred in the “address” field: “mousedown-mouseup-contextmenu-paste”).

Depending on the data collected during this analysis, a human decision can be made (for example by a group 4 of people such as marketing management) to modify the form, for example if statistics show some users have difficulties filling out the form correctly or quickly enough. To that end, the person authorized to access analysis server 3 can consult (step 41 of FIG. 1), on a daily basis for example, the analyses of the technical traces recorded in database 30 of analysis server 3, and consequently define (step 42 of FIG. 1) a plan of action.

According to another embodiment illustrated in FIG. 2, application server 2 can request (step 231 of FIG. 2) an analysis of the technical traces that have been transferred to it from analysis server 3 (step 232 of FIG. 2) following the processing of the submitted form (for example, for accepting or rejecting a banking transaction in the case of an e-banking form).

In this embodiment, analysis server 3 itself is configured to apply the rules of processing the form (step 34 of FIG. 2).

In particular, the system and the method as described above make it possible, based on a statistical behavioral analysis (anonymous) of the user interactions, to modify the architecture of the forms in order to improve the ergonomics without the need to modify the client terminals, in terms of hardware as well as software.

The behavioral characteristics of the user in particular comprise the way in which the user uses a data entry peripheral (the keyboard and/or the mouse for example).

It is also feasible to place several types of forms on line depending on the assumed performances of the users. The different types of forms can thus entail different functionalities (particularly aid in filling it out, for example by means of drop-down menus instead of free data entry window).

Moreover, it is obvious that variants of embodiment are feasible. Thus, application server 2 can also perform the function of analysis server 3.

1. A method of managing an electronic form accessible on an application server (2) via a user terminal (10) provided with at least one input peripheral, said method comprising the following steps:
upon the loading of the electronic form by the user terminal (10), identification (11) of the fields of the electronic form that could be involved in user interactions;
detection and storing in memory of data concerning any event occurring each of the identified fields;
downloading of the data stored in memory during submission of the electronic form;
analysis of the downloaded data, said analysis step comprising a step of identifying chains of successive events resulting from user interactions.

2. The method according to claim 1, wherein the identification step comprises a step of storing in memory properties of the identified fields.

3. The method according to claim 1, further comprising a step of associating a listener with each identified field of the electronic form in order to detect any event occurring in said field.

4. The method according to claim 1, wherein the events to be detected are selected from among the following events: keydown, keypress, keyup, focus, blur, select, paste, cut, copy, change, click, double-click, contextmenu, mousedown, mouseup, resize, mouseover, mouseout.

5. The method according to claim 1, wherein the data stored in memory concerning an event occurring in unidentified field are selected from among the event occurred, the field in which the event occurred, the time elapsed since the preceding event, the instruction transmitted from the input peripheral to the user terminal, the new value of the field, a modification of the value of a field, the status of special keys of the input peripheral.

6. The method according to claim 1, wherein the step of downloading data stored in memory comprises an operational formatting data stored in memory and then operation of adding formatted data to the electronic form.

7. The method according to claim 6, wherein the data stored in memory are formatted to comprise a heading, a structure and a trace of the events that occurred.

8. The method according to claim 7, wherein the trace of events that occurred is encrypted.

9. An events recorder for managing an electronic form accessible on an application server (2) via a user terminal (10) provided with at least one input peripheral, said event recorder configured to:
upon the loading of the electronic form by the user terminal (10), identify (11) the fields of the electronic form that could be involved in user interactions;
detect and store in memory data concerning any event occurring in each of the identified fields;
downloading the memorized data download, during the submission of the electronic form, the data stored in memory to analysis server (3) configured to identify in said data stored in memory at least one chain of successive events resulting from user interaction.

10. The events recorder according to claim 9, the events recorder attached to the electronic form requested by the user terminal (10), in response to a request for access (120) to this electronic form, issued from the user terminal (10).

11. A computer program implemented on a memory device, capable of being run on an electronic data processing unit and comprising instructions for the implementation of a method according to claim 1

12. Method according to claim 2, further comprising a step of associating a listener with each identified field of the electronic form in order to detect any event occurring in said field.
